(19) United States
(12) Patent Application Publication
(10) Pub. No.: US 2025/0323868 A1
(43) Pub. Date: Oct. 16, 2025

(54) SOLUTION FOR ROUTING IN A PARTITIONED SUBNET BASED ON DYNAMIC LIVENESS MONITORING

(71) Applicant: Cisco Technology, Inc., San Jose, CA (US)

(72) Inventors: Clarence Filsfils, Brussels (BE); Pablo Camarillo Garvia, Madrid (ES); Rakesh Gandhi, Ontario (CA)

(21) Appl. No.: 18/634,795

(22) Filed: Apr. 12, 2024

(51) Int. Cl. H04L 45/748; H04L 45/00; H04L 45/028

(52) U.S. Cl. CPC H04L 45/748; H04L 45/028; H04L 45/66

(57) ABSTRACT

Routing of packets in a partitioned subnet is realized in a data center (DC) by using a first type of address prefix (e.g., /24 prefixes) to advertise respective hosts to its peers (i.e., external traffic). For routing traffic within the DC (i.e., internal traffic), a second type of address prefix (e.g., /32 prefixes) that is longer than the first type. Switches/routers within the DC perform liveness probes detecting which hosts are connected thereto and updating a table (e.g., an ARP/ND table) to include the connected hosts (e.g., removing hosts that fail to respond). For changes to the table, a gate protocol (e.g., BGP or IGP) is triggered such that the switch/router advertises within the DC fabric the second type of address prefix for the host routes of the connected host. The switch/router also configures Liveness sessions for the connected hosts.

### BACKGROUND

Data centers include various networking components, such as routers, switches, processors, and memory storages, that can be used for applications such as cloud computing, hosting websites, etc. Rather than a company buying dedicated computer hardware, they can subscribe to a service in which a data center provides them with the computing resources that the company needs. Then as the company's computing and storage needs grow and/or shrink, more or less resources within the data center can be provisioned to run the company's software.

To achieve load balancing, multiple virtual machines (VMs) can operate on a single server. When one server is being underutilized and another server is overutilized, some of the VMs on the overutilized server can be moved to the underutilized server, achieving a more uniform balance in how the computing hardware is being used.

VM mobility can, however, present a networking challenge for partitioned subnets, which occur when VMs that are part of the same subnet are running on servers that are connected to different switches/routers. For example, when a VM is moved from one server to another, the VM preserves the IP address assigned to it, resulting in a partitioned subnet in which the same subnet is spread among several Top of Rack (ToR) switches or routers. The partitioned subnet can be handled using an L2 switch and a bridge network that extends from one ToR switch to the other ToR switch. However, the bridge-network solution to partitioned subnets has several drawbacks. For example, the hardware to implement the bridge network and the L2 switch is expensive. Further, the bridge-network solution is not scalable and is complex to operate). Additionally, there may be silent hosts on the subnet that are not detected, which can cause a silent host problem.

Accordingly, an improved solution for routing in partitioned subnets is desired.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a data center, in accordance with some embodiments.

FIG. 2A illustrates a diagram of an example of routing traffic to respective hosts in a data center, in accordance with some embodiments.

FIG. 2B illustrates a diagram of an example of a bridge network for routing traffic to a partitioned subnet of a data center, in accordance with some embodiments.

FIG. 3A illustrates a diagram of an example of setting up a Liveness session (e.g., in a loopback mode) when an entry is made in an address resolution protocol (ARP) table or Neighbor Discovery (ND) table, in accordance with some embodiments.

FIG. 3B illustrates a diagram of an example of setting up another Liveness session (e.g., in a loopback mode) when a second entry is made in the ARP or ND table, in accordance with some embodiments.

FIG. 3C illustrates a diagram of an example of changes made when a host is moved from one switch to another switch, in accordance with some embodiments.

FIG. 3D illustrates a diagram of an example of dual-homing, in accordance with some embodiments.

FIG. 4 illustrates a flow diagram of an example of a method, in accordance with some embodiments.

FIG. 5A illustrates a block diagram of an example of a first system for liveness detection of a dynamic local host endpoint, in accordance with some embodiments.

FIG. 5B illustrates a block diagram of an example of a second system for liveness detection of a dynamic local host endpoint, in accordance with some embodiments.

FIG. 6 illustrates a flow diagram of an example of a method for liveness detection of a dynamic local host endpoint, in accordance with some embodiments.

FIG. 7A illustrates a diagram of an example of a Liveness session using performance measurement probes for liveness detection of a dynamic local host endpoint, in accordance with some embodiments.

FIG. 7B illustrates a flow diagram of an example of a method for performing the Liveness monitoring session for liveness detection of a dynamic local host endpoint, in accordance with some embodiments.

FIG. 8A illustrates a block diagram of an example of a first system for liveness detection of a dynamic host endpoint in a remote subnet, in accordance with some embodiments.

FIG. 8B illustrates a block diagram of an example of a second system for liveness detection of a dynamic host endpoint in a remote subnet, in accordance with some embodiments.

FIG. 9 illustrates a flow diagram of an example of a method for liveness detection of a dynamic host endpoint in a remote subnet, in accordance with some embodiments.

FIG. 10A illustrates a block diagram of an example of a first system for liveness detection with dynamic BGP next-hop tracking, in accordance with some embodiments.

FIG. 10B illustrates a flow diagram of an example of a method for liveness detection with dynamic BGP next-hop tracking, in accordance with some embodiments.

FIG. 11 illustrates a block diagram of an example of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, the techniques described herein relate to a method of routing packets in a partitioned subnet, the method including: advertising, by a data center (DC) to peers of the DC, a first host using a first address prefix; routing, within a fabric of the DC, traffic to the first host using a second address prefix for a host route of the first host within the fabric of the DC, wherein the second address prefix is a longer prefix than the first address prefix; and performing, by a first switch of the DC, a first probe that detects whether the first host is linked to the first switch; and updating a first table of the first switch based on a first result of the first probe.

In some aspects, the method, further includes updating a first table by adding to the first table the second address prefix in association with a MAC address of the first host; triggering a gateway protocol for the host route of the first host to advertise the second address prefix for the host route of the first host within the fabric of the DC; and configuring a performance measurement (PM) session for the host route of the first host.

In some aspects, the method, further includes that the DC aggregates a plurality of host routes within the fabric of the DC into the first address prefix, wherein the plurality of host routes includes the host route of the first host to a single; and the plurality of host routes are de-aggregated from the first address prefix by redistributing the plurality of host routes using a gateway protocol that is triggered upon the host route of the first host or the second address prefix being added to or removed from the first table.

In some aspects, the method, further includes that the gateway protocol is a border gateway protocol (BGP) or an interior gateway protocol (IGP).

In some aspects, the techniques described herein relate to a method, wherein the method is performed in a network layer that is a layer 3 (L3) of an open systems interconnection (OSI) model.

In some aspects, the method, further includes that the first host is a virtual machine (VM) running on a first server that is linked to the first switch, and the DC includes a second server that is linked to a second switch.

In some aspects, the method, further includes moving the first host from the first server to the second server; performing a second probe by the first switch that returns a second result indicating that the first host is not running on the first server; removing the host route of the first host from the first table.

In some aspects, the method, further includes performing a third probe by the second switch that returns a third result indicating that the first host is running on the second server; adding the host route of the first host to a second table, wherein the second table is associated with host routes of the second switch.

In some aspects, the method, further includes performing a second probe by the second switch, the second probe returning a second result indicating that the first host is linked to the second switch; and adding the host route of the first host to a second table, wherein the second table is associated with host routes of the second switch, wherein the first host is a virtual machine (VM) that is dual-homed, such that the VM is linked to the first switch and is linked to the second switch.

In some aspects, the method, further includes that the first address prefix is a /24 prefix; the second address prefix is a /32 prefix; the first table is an address resolution protocol (ARP) table; the first switch is a top-of-rack switch; the first probe is a performance measurement (PM) liveness probe; and the first host is a virtual machine (VM) or a virtual network function (VNF).

In another aspect, similar to 32-bit IPv4 prefix, 128-bit IPv6 prefix are contained in the routing table based on Neighbor Discovery protocol that employ the techniques described herein, wherein an address /128 prefix is in place of the address /32 prefix that is used as non-limiting illustrative example throughout the figures. Generally, the second address prefix can be a /XX prefix, wherein XX is an integer (e.g., a power of 2).

In another aspect, the techniques described herein relate to a system for routing packets in a network that has partitioned subnets, including: a data center (DC) including: a fabric of the DC; a first switch; and a first server configured to run a first host that is linked to the first switch, wherein the DC is configured to: advertise, to peers of the DC, a first host using a first address prefix, and route, within the fabric of the DC, traffic to the first host using a second address prefix for a host route of the first host within the fabric of the DC, the second address prefix being a longer prefix than the first address prefix; and the first switch is configured to: perform a first probe that detects whether the first host is linked to the first switch, and update a first table of the first switch based on a first result of the first probe.

In some aspects, the system further includes that the first switch is further configured to: update a first table by adding to the first table the second address prefix in association with a Media Access Control (MAC) address of the first host; trigger a gateway protocol for the host route of the first host to advertise the second address prefix for the host route of the first host within the fabric of the DC; and configure a performance measurement (PM) session for the host route of the first host.

In some aspects, the system further includes that the DC is further configured to: aggregate a plurality of host routes within the fabric of the DC into the first address prefix, wherein the plurality of host routes includes the host route of the first host to a single; and de-aggregate the plurality of host routes from the first address prefix by redistributing the plurality of host routes using a gateway protocol that is triggered upon the host route of the first host or the second address prefix being added to or removed from the first table.

In some aspects, the system further includes that the gateway protocol is a border gateway protocol (BGP) or an interior gateway protocol (IGP).

In some aspects, the system further includes that the method is performed in a network layer that is a layer 3 (L3) of an open systems interconnection (OSI) model.

In some aspects, the system further includes a second switch; a first server that is linked to the fabric of the DC via the first switch; and a second server that is linked to the fabric of the DC via the second switch, wherein the first host is a virtual machine (VM) running on the first server that is linked to the first switch.

In some aspects, the system further includes that, when the first host is moved from the first server to the second server: the first switch is configured to: perform a second probe that returns a second result indicating that the first host is not running on the first server, and remove the host route of the first host from the first table; and the second switch is configured to: perform a third probe that returns a third result indicating that the first host is running on the second server, and add the host route of the first host to a second table, wherein the second table is associated with host routes of the second switch.

In some aspects, the system further includes that the second switch is configured to: perform a second probe returning a second result indicating that the first host is linked to the second switch; and add the host route of the first host to a second table, wherein the second table is associated with host routes of the second switch, and the first host is a virtual machine (VM) that is dual-homed, such that the VM is linked to the first switch and is linked to the second switch.

In some aspects, the system further includes that the first address prefix is a /24 prefix; the second address prefix is a /32 prefix; the first table is an address resolution protocol (ARP) table; the first switch is a top-of-rack switch; the first probe is a performance measurement (PM) liveness probe; and the first host is a virtual machine (VM) or a virtual network function (VNF).

In an additional aspect, the techniques described herein relate to a computing apparatus including: a processor; and a memory storing instructions that, when executed by the processor, configure the apparatus to: advertise, by a data center (DC) to peers of the DC, a first host using a first address prefix; rout, within a fabric of the DC, traffic to the first host using a second address prefix for a host route of the first host within the fabric of the DC, wherein the second address prefix is a longer prefix than the first address prefix; and perform, by a first switch of the DC, a first probe that detects whether the first host is linked to the first switch; and update a first table of the first switch based on a first result of the first probe.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved/scalable routing in partitioned subnets.

According to certain non-limiting examples, the systems and methods disclosed herein have the benefit of building on and reusing existing networking protocols. For example, the systems and methods disclosed herein can use the border gateway protocol (BGP). Further, the systems and methods disclosed herein can reuse existing technology for the Address Family Identifier (AFI), and the systems and methods disclosed herein can reuse existing technology for the Subsequent Address Family Identifier (SAFI), e.g., by reusing the classic IPv4 unicast or IPv6 unicast technology. Additionally, the systems and methods disclosed herein can be used with and are applicable to any BGP use-case (e.g., VPN, Internet, etc.).

According to certain non-limiting examples, the systems and methods disclosed herein provide routing in partitioned internet protocol (IP) subnet using an on-demand (dynamic) performance measurement (PM) based liveness monitoring, without the need for any new BGP signaling protocol extensions. For example, the solution can create on-demand liveness monitoring sessions of dynamic IP/Host in a data center using a two-way active measurement protocol (TWAMP) protocol (RFC 5357), Simple Two-way Active Measurement Protocol (e.g., RFC 8762) or Bidirectional Forwarding Detection (BFD) (RFC 5880) in loopback mode with specifically crafted packets.

According to certain non-limiting examples, the systems and methods disclosed herein do not require PM (TWAMP or STAMP) protocol support on hosts (e.g., virtual machines (VMs) and virtual network functions (VNFs)) in data centers and does not require support for IP-in-IP tunneling encoding.

According to certain non-limiting examples, the systems and methods disclosed herein use automatic PM-based liveness sessions that are created for local IP subnets by ARP/ND (based on local discovery) and for remote IP subnets by BGP route updates (e.g., using Proxy-ARP) to monitor dynamic hosts in both local and remote IP subnets.

According to certain non-limiting examples, the systems and methods disclosed herein eliminate the need to aggregate the host routes on Top-of-Rack (ToR), which has been used for VM migration from one partitioned IP subnet to another.

According to certain non-limiting examples, the systems and methods disclosed herein the ARP/ND cache is refreshed when the liveness session fails, thereby immediately triggering BGP route updates in the network. The solution is also applicable to round-trip latency and packet loss measurement between ToR and local/remote hosts in DC.

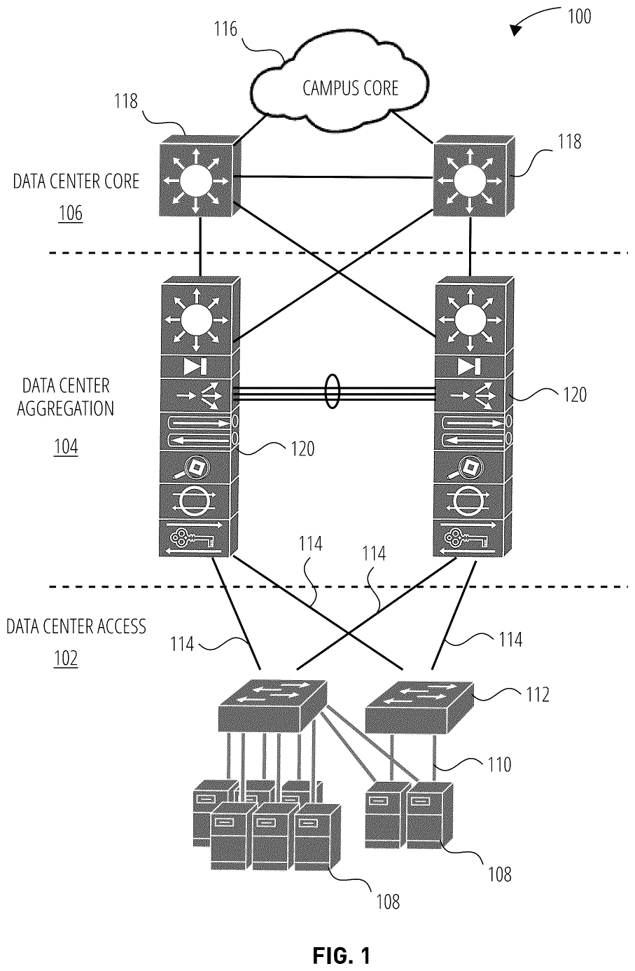

FIG. 1 illustrates a non-limiting example of a data center 100, which includes data center access 102, data center aggregation 104, and data center core 106. Data center 100 can be a multi-tier data center. Data center 100 provides computational power, storage, and applications that can support an enterprise business, for example.

The network design of data center 100 can be based on a layered approach. The layered approach can provide improved scalability, performance, flexibility, resiliency, and maintenance. As shown in FIG. 1, the layers of data center 100 can include the core, aggregation, and access layers (i.e., data center core 106, data center aggregation 104, and data center access 102).

Data center core 106 layer can include switches 118 and a campus core 116. Data center core 106 layer provides the high-speed packet switching backplane for all flows going in and out of data center 100. Data center core 106 can provide connectivity to multiple aggregation modules and provides a resilient Layer 3 routed fabric with no single point of failure. Data center core 106 can run an interior routing protocol, such as Open Shortest Path First (OSPF) or Intermediate System to Intermediate System (IS-IS) or Enhanced Interior Gateway Routing Protocol (EIGRP), and load balances traffic between the campus core and aggregation layers using forwarding-based hashing algorithms, for example.

The data center aggregation 104 layer can provide functions such as service module integration, Layer 2 domain definitions, spanning tree processing, and default gateway redundancy. Server-to-server multi-tier traffic can flow through the aggregation layer and can use services, such as firewall and server load balancing, to optimize and secure applications. The smaller icons within the aggregation layer switch in FIG. 1 represent the integrated service modules. These modules provide services, such as content switching, firewall, SSL offload, intrusion detection, network analysis, and more.

Data center access 102 layer is where the servers physically attach to the network. The server components can be, e.g., 1RU servers, blade servers with integral switches, blade servers with pass-through cabling, clustered servers, and mainframes with OSA adapters The access layer network infrastructure can include modular switches, fixed configuration 1 or 2RU switches, and integral blade server switches. Switches provide both Layer 2 and Layer 3 topologies, fulfilling the various server broadcast domain or administrative requirements.

The architecture in FIG. 1 is an example of a multi-tier data center, but server cluster data centers can also be used. The multi-tier approach can include web, application, and database tiers of servers. The multi-tier model can use software that runs as separate processes on the same machine using inter-process communication (IPC), or the multi-tier model can use software that runs on different machines with communications over the network. Typically, the following three tiers are used: (i) Web-server; (ii) Application; and (iii) Database. Further, multi-tier server farms built with processes running on separate machines can provide improved resiliency and security. Resiliency is improved because a server can be taken out of service while the same function is still provided by another server belonging to the same application tier. Security is improved. For example, an attacker can compromise a web server without gaining access to the application or database servers. Web and application servers can coexist on a common physical server, but the database typically remains separate. Load balancing the network traffic among the tiers can provide resiliency, and security is achieved by placing firewalls between the tiers. Additionally, segregation between the tiers can be achieved by deploying a separate infrastructure composed of aggregation and access switches, or by using virtual local area networks (VLANs). Further, physical segregation can improve performance because each tier of servers is connected to dedicated hardware. The advantage of using logical segregation with VLANs is the reduced complexity of the server farm. The choice of physical segregation or logical segregation depends on your specific network performance requirements and traffic patterns.

Data center access 102 includes one or more of access server clusters 108, which can include layer 2 access with clustering and network interface controller (NIC) teaming. Access server clusters 108 can be connected via gigabit ethernet (GigE) connections 110 to workgroup switches 112. The access layer provides the physical level attachment to the server resources and operates in Layer 2 or Layer 3 modes for meeting particular server requirements such as NIC teaming, clustering, and broadcast containment.

Data center aggregation 104 can include aggregation processor 120, which is connected via 10 gigabit ethernet (10 GigE) connections 114 to data center access 102 layer.

The aggregation layer can be responsible for aggregating the thousands of sessions leaving and entering the data center. The aggregation switches can support, e.g., many 10 GigE and GigE interconnects while providing a high-speed switching fabric with a high forwarding rate. Aggregation processors 120 can provide value-added services, such as server load balancing, firewalling, and SSL offloading to the servers across the access layer switches. The switches of aggregation processors 120 can carry the workload of spanning tree processing and default gateway redundancy protocol processing.

For an enterprise data center, data center aggregation 104 can contain at least one data center aggregation module that includes two switches (i.e., aggregation processors 120). The aggregation switch pairs work together to provide redundancy and to maintain the session state. For example, the platforms for the aggregation layer include the CISCO CATALYST 6509 and CISCO CATALYST 6513 switches equipped with SUP720 processor modules. The high switching rate, large switch fabric, and ability to support a large number of 10 GigE ports are important requirements in the aggregation layer. Aggregation processors 120 can also support security and application devices and services, including, e.g.: (i) Cisco Firewall Services Modules (FWSM); (ii) Cisco Application Control Engine (ACE); (iii) Intrusion Detection; (iv) Network Analysis Module (NAM); and (v) Distributed denial-of-service attack protection.

Data center core 106 provides a fabric for high-speed packet switching between multiple aggregation modules. This layer serves as the gateway to campus core 116 where other modules connect, including, For example, the extranet, wide area network (WAN), and internet edge. Links connecting data center core 106 can be terminated at Layer 3 and use 10 GigE interfaces to support a high level of throughput, performance, and to meet oversubscription levels. According to certain non-limiting examples, data center core 106 is distinct from the campus core 116 layer, with different purposes and responsibilities. Data center core 106 is not necessarily required, but is recommended when multiple aggregation modules are used for scalability. Even when a small number of aggregation modules are used, it might be appropriate to use the campus core for connecting the data center fabric.

Data center core 106 layer can connect, e.g., to campus core 116 and data center aggregation 104 layers using Layer 3-terminated 10 GigE links. Layer 3 links can be used to achieve bandwidth scalability, quick convergence, and to avoid path blocking or the risk of uncontrollable broadcast issues related to extending Layer 2 domains.

The traffic flow in the core can include sessions traveling between campus core 116 and aggregation processors 120. Data center core 106 aggregates the aggregation module traffic flows onto optimal paths to campus core 116. Server-to-server traffic can remain within aggregation processor 120, but backup and replication traffic can travel between aggregation processors 120 by way of data center core 106.

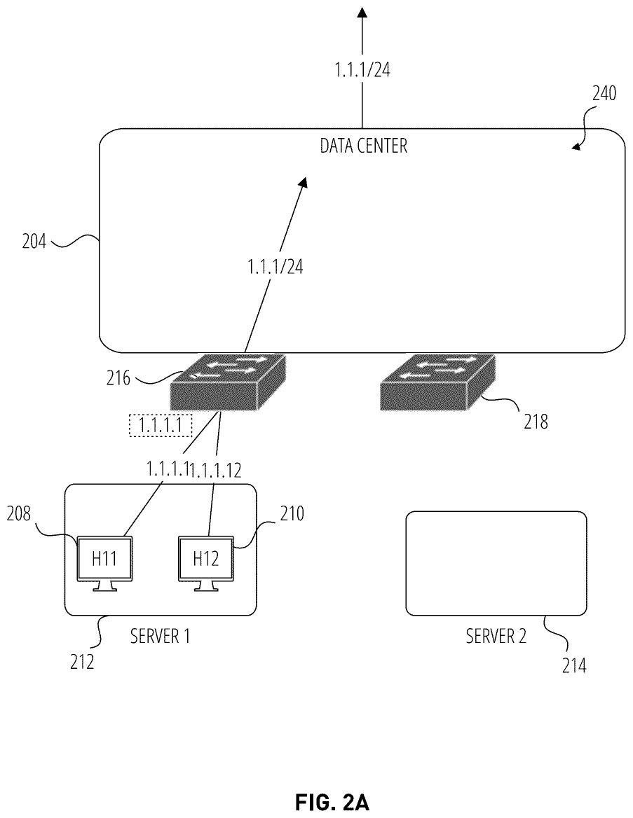

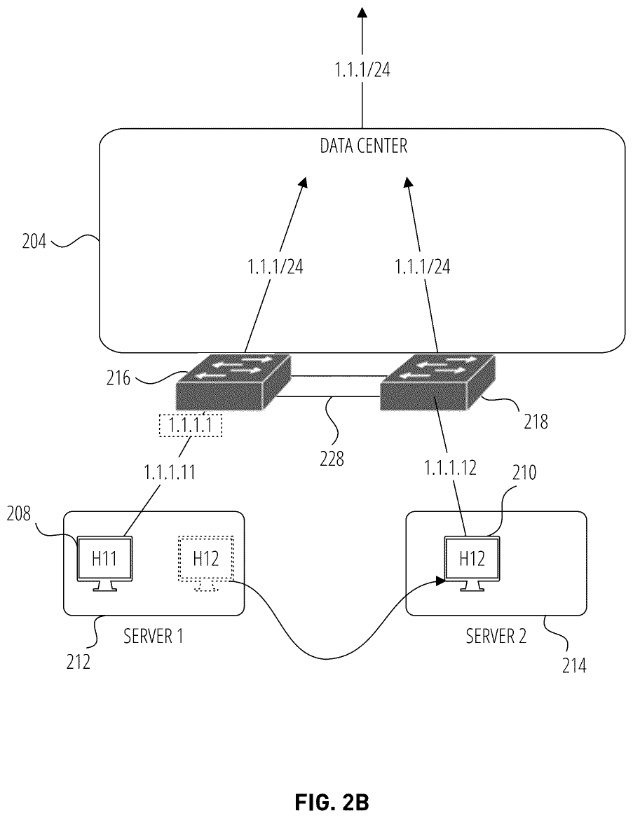

FIG. 2A and FIG. 2B illustrate a diagram of an example for routing traffic in a data center 204 having partitioned subnets. The first subnet includes switch 1 216 and server 1 212, on which are running two hosts (i.e., H11 208 and H12 210). The second subnet includes switch 2 218 and server 2 214. As shown in the non-limiting example of FIG. 2A, the switch has IP address 1.1.1.1 and hosts H11 208 and H12 210 have IP addresses 1.1.1.11 and 1.1.1.12, respectively. Switch 1 216 advertise routes using an address prefix of 1.1.1/24, and the data center 204 advertise routes using an address prefix of 1.1.1/24. The servers (i.e., server 1 212 and server 2 214) can correspond to the access server clusters 108 in FIG. 1. Data center 204 can include data center interconnect 240 (fabric) that corresponds to one or more elements in data center aggregation 104 layer and/or one or more elements in the data center core 106 layer, which are illustrated in FIG. 1. Further, switches (i.e., switch 1 216 and switch 2 218) can correspond to workgroup switches 112, which is illustrated in FIG. 1.

The two hosts can be virtual machines (VM), and the data center 204 can support VM mobility. That is, a VM can move from one server to another (e.g., to achieve load balancing).

FIG. 2B illustrates a diagram of routing traffic in the data center 204 in which host H12 210 has been moved from server 1 212 to server 2 214. Commonly, when a VM is moved from one server to another, the VM preserves the IP address assigned to it. Here, H12 210 keeps the IP address 1.1.1.12. This results in a partitioned subnet in which the same subnet is spread among several Top of Rack (ToR) switches or routers. Here, network devices (i.e., switch 1 216 and switch 2 218) are referred to as switches, but the network devices could instead be routers without deviating from the spirit of the disclosure. The partitioned subnet presents several challenges, which can be solved using bridge network 228 in an L2 switch. That is, bridge network 228 is extended from one ToR switch (i.e., switch 1 216) to the other (i.e., switch 2 218). This solution has several drawbacks (e.g., the hardware that is used to implement the bridge-network solution is expensive, it is not scalable, and it is complex to operate). Accordingly, the systems and methods disclosed herein provide an improved solution to VM mobility in partitioned subnets that has advantages with respect to cost, scalability, and complexity. This improved solution is an internet protocol (IP) based solution.

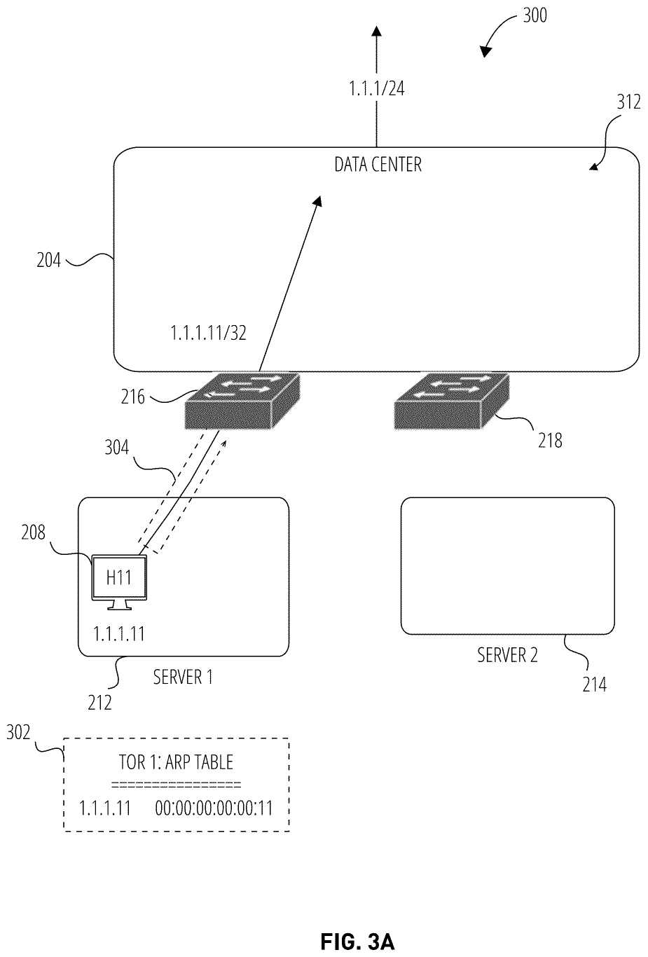

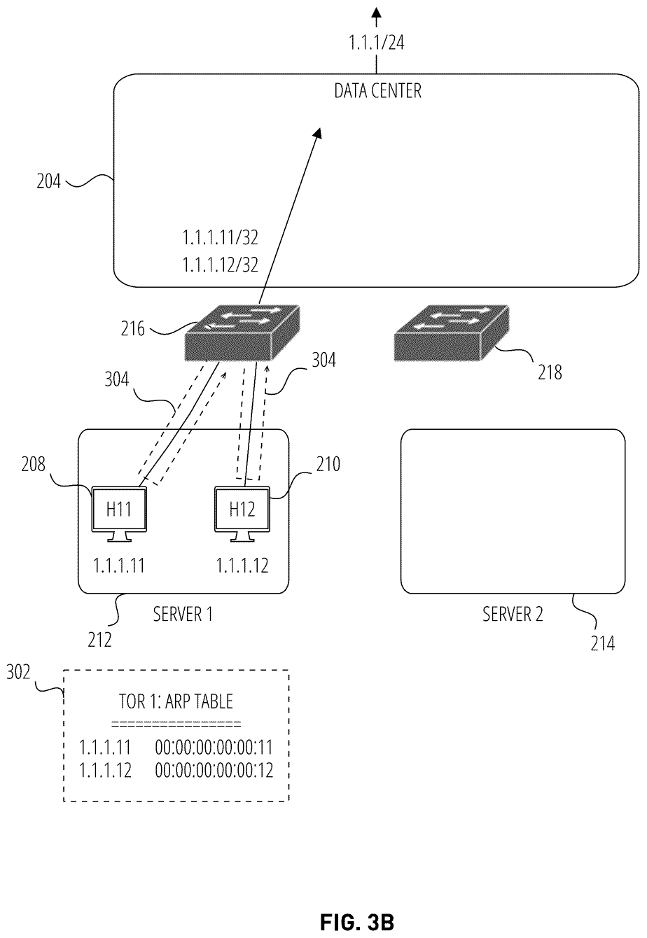

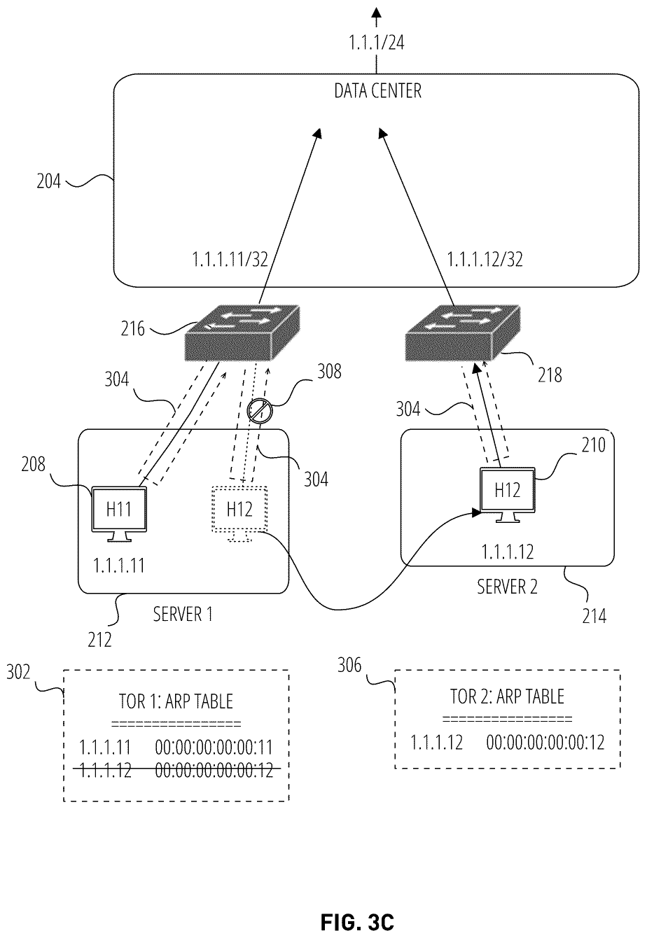

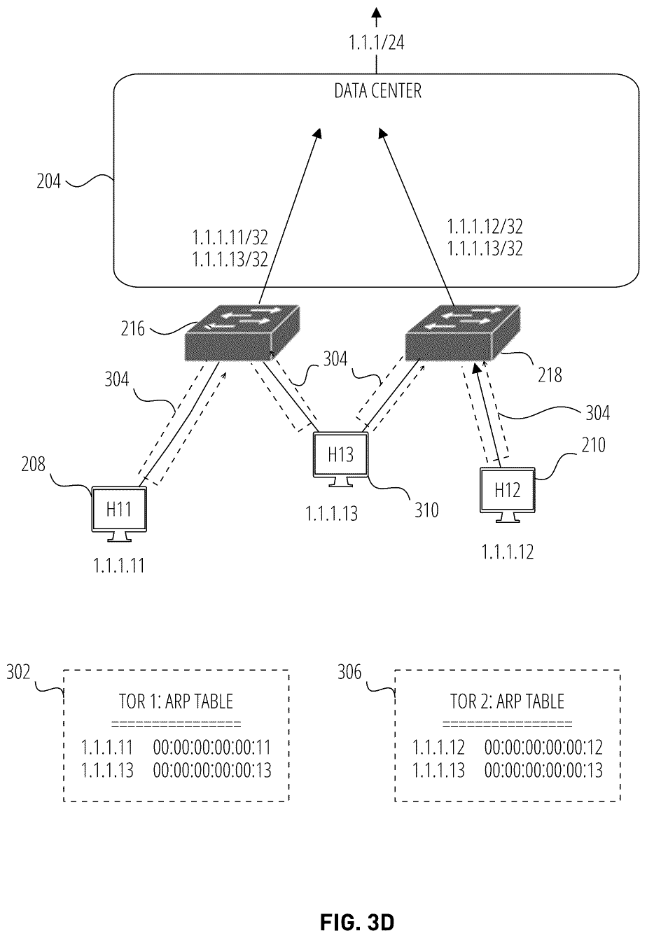

FIG. 3A illustrates a non-limiting example of the IP-based solution for partitioned subnets. Rather than advertising a /24 address prefix with the fabric of the DC (as illustrated in FIG. 2A and FIG. 2B), system 300 has switch 1 216 advertise a /32 address prefix within the fabric of data center 204. Switch 1 216 performs Liveness probe 304 to elicit a response indicating that H11 208 is present and has an IP address of 1.1.1.11. Upon receiving a response to Liveness probe 304, server 1 212 enters the host route for H11 208 into ARP table 302, which associates the IP address with the MAC address of H11 208.

Additionally, the response to Liveness probe 304 triggers a BGP Host Route to advertise the address prefix 1.1.1.11/32 within the fabric of data center 204, which is also referred to as the data center interconnect (DCI). That is, instead of advertising the entire subnet, server 1 212 only advertises /32 routes for the hosts that are connected to it. For example, if a VM in the subnet is moved to another switch (as illustrated in FIG. 3C), then the other switch would advertise the /32 route of the move VM.

Data center 204 aggregates the host routes (e.g., 1.1.1.11/32) into one single prefix (e.g., 1.1.1/24) that is advertised to the peers of data center 204.

To summarize so far, the IP-based solution that is illustrated in FIG. 3A (and further illustrated in FIG. 3B and FIG. 3C) provides traffic routing in partitioned subnets without bridge networks by using, e.g., a combination of Liveness probes, ARP tables, and BGP Host Routes. This combination allows the de-aggregation of the routes within DCI 312 (e.g., the fabric of data center 204), such that each switch only advertises the /32 routes for the hosts that are connected to that switch, rather than for the entire subnet.

According to certain non-limiting examples, routing in a partitioned subnet is realized by de-aggregating the ToR switches. ToR switches of system 300 are de-aggregated by having each of the ToR switches only advertise those /32 routes for the hosts that are connected to it, rather than the ToR switch advertising the entire subnet. DCI 312 aggregates all the host routes that are advertised by the respective ToR switches into one single prefix (e.g., a /24 address prefix, such as IPv4 1.1.1/24), and the single prefix to advertised by the data center 204 to the peers of the data center 204 (e.g., other data centers. This IP-based solution eliminates the routing scale impact of the bridge-network solution.

According to certain non-limiting examples, de-aggregation is achieved with classic routes redistributed in IGP/BGP. The IGP/BGP routes are triggered together with changes to the Address Resolution Protocol (ARP) Cache. For example, when the Liveness probe 304 results in a new entry into ARP table 302 for H11 208, a BGP route update is triggered, resulting in the BGP Host Route (e.g., IPv4 1.1.1.11/32) being advertised within DCI 312 by the respective switch (e.g., switch 1 216) connected to the host (e.g., H11 208).

According to certain non-limiting examples, the IP-based solution is enabled by static address allocation and dynamic address allocation.

In static address allocation, the switches/routers and hosts are configured using a Software-Defined Networking (SDN) solution, and system 300 is configured to redistribute static routes using IGP/BGP signal processes.

In dynamic address allocation, a BGP Host Route is triggered on a given switch, when an ARP entry (or neighbor discovery (ND)) is added to the ARP/ND table. For example, in FIG. 3A, a BGP Host Route is triggered for H11 208 when the entry “1.1.1.11 00:00:00:00:00:11” is entered in ARP table 302. Furthermore, a Performance-Measurement (PM) based liveness detection session is configured against the host route <1.1.1.11>. This Liveness Session enables checking the liveness (i.e., connectivity verification (CV) and connectivity check (CC)) of the host, mitigating the silent host problem. The Liveness Session also has the benefit that it scales because the liveness checks can be periodically performed at infrequent time intervals (e.g., the period can be between 1 second and 10 seconds). When the Liveness Session detects that the host is no longer connected to the switch, the entry for that host is cleared/removed from ARP table 302 and the related BGP Host Route is also cleared/removed.

The IP-based solution can also provide dual-homing. When one of the VMs is dual-homed, then each of the ToR switches with which the VM is homed is configured with a respective Liveness Session, such that, in the event that one of the link fails, the route is cleared/removed from the routing table by the ToR switch for which the link failed.

According to certain non-limiting examples, the IP-based solution provides a mechanism that can scalably handle VM mobility, and this solution is based entirely in layer three (L3 or the network layer) of the Open Systems Interconnection (OSI) model. According to certain non-limiting examples, the IP-based solution combines existing processes and building blocks in new ways to provide new functionality for routing traffic to partitioned subnets (e.g., in data centers). For example, the address resolution protocol (ARP) in IPv4 or Neighbor Discovery (ND) in IPv6 can be used for host learning, Further, the IP-based solution can use BGP host routes, IP prefix aggregation and de-aggregation, and Liveness probes/sessions. So, how do these building blocks work together,

As illustrated in FIG. 3A, when host H11 208 connects to a top-of-rack (ToR) switch (e.g., switch 1 216), the ToR switch causes an entry in ARP table 302. The ARP protocol can link the IP address to a MAC address for respective hosts. When there is a new entry (or change to an entry) in ARP table 302, the ToR switch triggers the advertisement of a corresponding BGP route (e.g., 1.1.1.11/32).

In addition to advertising the BGP route, a Liveness session is also instantiated, when there is a new entry in ARP table 302. The Liveness session can cause a Liveness probe 304 to be performed periodically (e.g., once every 3 seconds). The Liveness probe 304 can include a probe packet that is sent at a given period, and the probe packet checks whether the host (e.g. H11 208) is still there.

PM liveness session for monitoring liveness of the host can be based on any standard monitoring and OAM protocol such as TWAMP (RFC 5357), STAMP (RFC 8762), BFD (RFC 5880), ITU Y.1731, Ping (RFC 792) and the like.

FIG. 3B illustrates a non-limiting example of adding a second host (H12 210) to server 1 212, which is connected to switch 1 216. Each of the hosts can be a virtual machine (VM) or virtual network function (VNF), for example.

When H12 210 is instantiated on server 1 212, another entry (i.e., “1.1.1.12 00:00:00:00:00:12”) is added to ARP table 302. The process discussed above for H11 208 is repeated for H12 210. That is, another BGP Host Route (e.g., 1.1.1.12/32) is advertised by switch 1 216. As with H11, the BGP Host Route 1.1.1.12/32 for H12 210 is going to advertise the routing all the way through the data center. And another Liveness Session (i.e., Liveness probe 304) is initiated on Switch 1 216 for H12 210.

FIG. 3C illustrates a non-limiting example of moving (H12 210 from server 1 212 to server 2 214, which is connected to switch 2 218. Because H12 210 is no longer connected to 216, Liveness probe 304 fails (shown via failure/reject sign 308) for the Liveness session between H12 210 and switch 1 216, resulting in the removal from ARP table 302 of the entry corresponding to H12 210.

When H12 210 is instantiated on server 2 214, an entry (i.e., “1.1.1.12 00:00:00:00:00:12”) is added to ARP table 306. A BGP Host Route (e.g., 1.1.1.12/32) is advertised by switch 2 218, and a Liveness Session (i.e., Liveness probe 304) is initiated on Switch 2 218 for H12 210. The BGP Host Route 1.1.1.12/32 for H12 210 is going to advertise the routing all the way through the data center. Thus, even though H11 208 and H12 210 are part of the same subnet, switch 1 216 advertises only the host route for H11 208, which is connected to it, and switch 2 218 advertises only the host route for H12 210, which is connected to it.

FIG. 3D illustrates a non-limiting example of dual-homing. In this case, H13 310 is connected to both switch 1 216 and switch 2 218. Both ARP table 302 and ARP table 306 include entries for H13 310. And both switches advertise the BGP Host Route for H13 310.

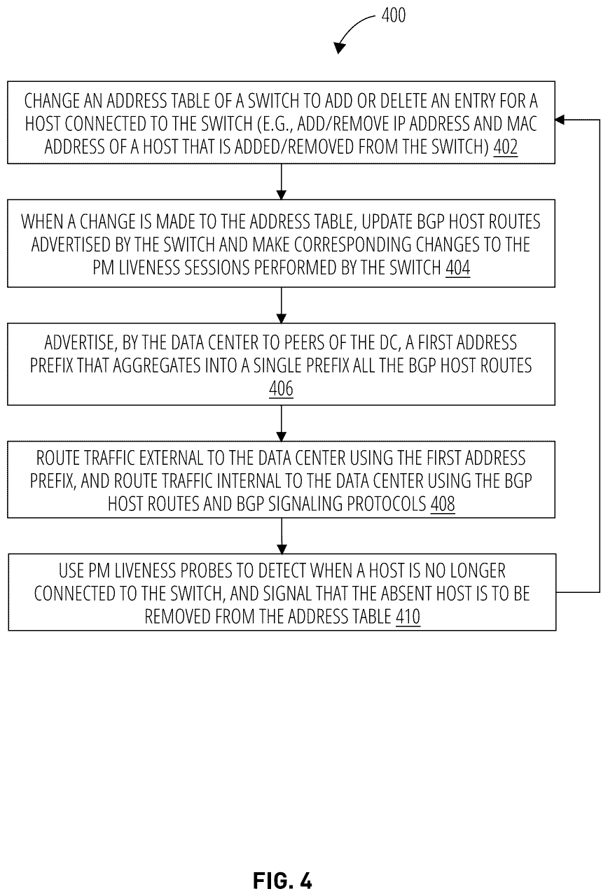

FIG. 4 illustrates an example of method 400 for routing traffic in partitioned subnets of a data center. Although the example method 400 depicts a particular sequence of operations, the sequence may be altered without departing from the scope of the present disclosure. For example, some of the operations depicted may be performed in parallel or in a different sequence that does not materially affect the function of the routing in the method 400. In other examples, different components of an example device or system that implements the method 400 may perform functions at substantially the same time or in a specific sequence.

According to some examples, in step 402, the method includes changing an address table (e.g., ARP table 302) of a switch (e.g., switch 1 216) to add or delete an entry for a host connected to the switch. For example, the change can be adding (or removing) an IP address and MAC address of a host that is added to (or removed from) a server that is connected to the switch.

According to some examples, in step 404, when a change is made to the address table, corresponding changes are made to the host routes and the Liveness sessions. For example, the BGP Host Routes can be added (or removed) to those that are being advertised by the switch. Further, Liveness sessions can be added (or removed) to those that are being performed by the switch.

According to some examples, in step 406, the data center 204 advertises a first address prefix to peers of data center 204. The first address prefix aggregates into a single prefix all the BGP host routes of the switches in the data center 204.

According to some examples, in step 408, traffic is routed externally to the data center using the first address prefix, and traffic is routed internally to the data center using the BGP host routes and BGP signaling protocols.

According to some examples, in step 410, Liveness probes are used to detect when a host is no longer connected to the switch. When the Liveness probes detects a missing host, an instruction is sent to remove the missing host from the address table, and method 400 returns to step 402 to implement the instruction by making the instructed change to the address table and all other changes precipitated by the change to the address table.

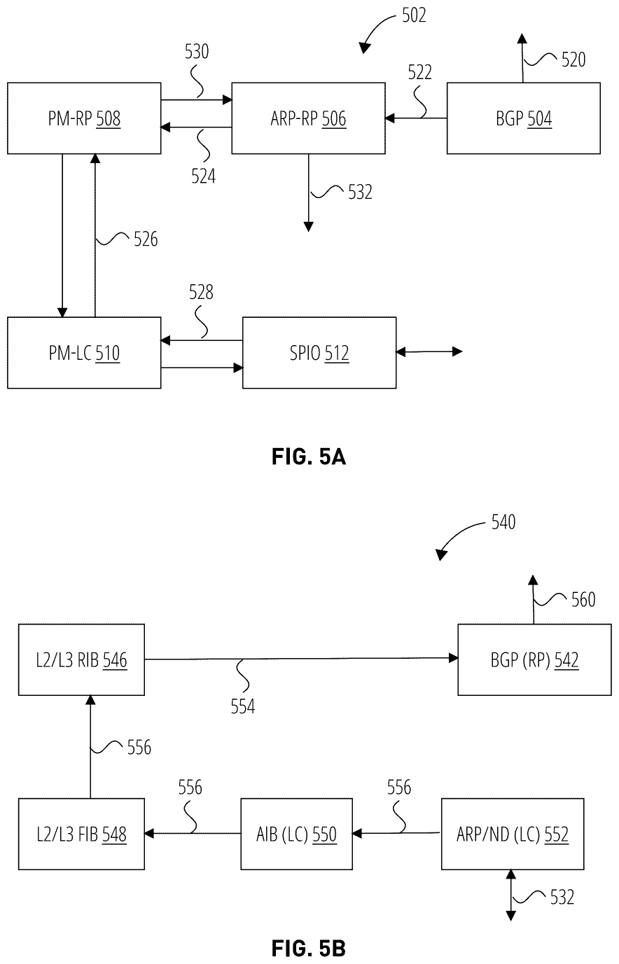

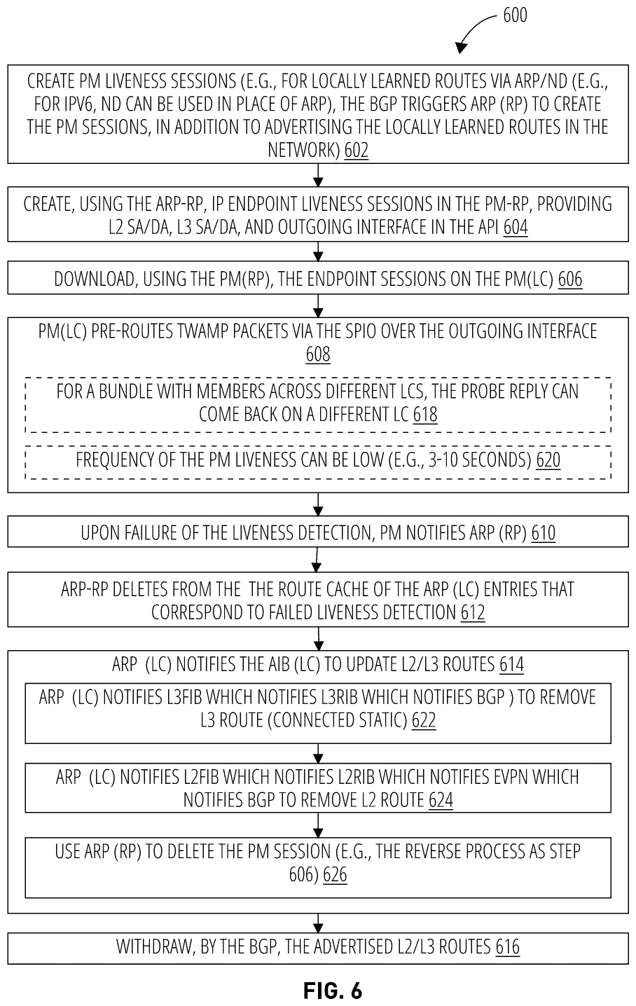

Now an example implementation is discussed for dynamic-local-host-endpoint liveness detection is discussed. FIG. 5A and FIG. 5B illustrate block diagrams for the dynamic-local-host-endpoint liveness detection. FIG. 6 illustrates an example method for dynamic-local-host-endpoint liveness detection.

FIG. 5A illustrates a system 1 502 that includes a border gateway protocol (BGP) 504, an address resolution protocol process running on a route processor (ARP-RP 506), a performance measurement process running on the route processor (PM-RP 508), a performance measurement process running on the line card PM-LC 510, Streamlined Packet Input/Output (I/O) (SPIO) process or Network Packet I/O (NETIO) process (e.g., process 512).

The blocks of system 1 502 interact and perform various functions. The BGP 504 performs a function to advertise routes via communications 520. and BGP 504 sends one or more instructions that signal ARP-RP 506 to trigger PM sessions via communications 522. ARP-RP 506 sends one or more instructions to PM-RP 508 to create/delete sessions via communications 524, and PM-RP 508 provides the liveness state via communications 530 to ARP-RP 506. ARP-RP 506 also sends one or more of communications 532 to delete the ARP cache of the line card (LC). PM-RP 508 sends one or more instructions to download (via communications 526) the end point session on PM-LC 510. PM-LC 510 sends one or more instructions to SPIO or NETIO process (e.g., process 512) to pre-route the L2 packets via communications 528.

FIG. 5B illustrates a system 2 540 that includes a BGP of the route processor BGP (RP) 542, a routing information base (RIB) for L2 and an RIB for L3 L2/L3 RIB 546, a forwarding information base (FIB) for L2 and a FIB for L3 L2/L3 FIB 548, an adjacency interface base for line card AIB (LC) 550, and an ARP/ND of line card ARP/ND (LC) 552.

The blocks of system 1 502 interact and perform various functions. BGP (running on RP) 542 performs a function to advertise routes 560. The ARP/ND (running on LC) 552 communicates with the local ARP (e.g., to delete a cache of the local ARP via communications 532). ARP/ND (running on LC) 552 sends one or more instructions to AIB (LC) 550 to update host routes via communications 556. AIB (LC) 550 sends one or more instructions to L2/L3 FIB 548 to update host routes via communications 556. And L2/L3 FIB 548 sends one or more instructions to L2/L3 RIB 546 to update host routes via communications 556. L2/L3 RIB 5468 sends one or more instructions to BGP (RP) 542 regarding L3 connected/static routes via communications 554.

FIG. 6 illustrates another example method 600 for routing traffic in partitioned subnets of a data center. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements method 600 may perform functions at substantially the same time or in a specific sequence.

According to some examples, in step 602, BGP 504 creates Liveness sessions (via communications 522), and BGP 504 advertises the locally learned routes in the network (via communications 520). For IPv6, ARP can be used to learn routes, and, for IPv6, ND can be used to learn the routes, rather than ARP. BGP 504 triggers ARP-RP 506 to create the Liveness sessions, in addition to BGP 504 advertising the locally learned routes in DCI 312.

According to some examples, in step 604, ARP-RP 506 creates/deletes IPv4/IPv6 (IP) endpoint liveness in the PM-RP 508 (via communications 524). Further, PM-RP 508 responds by providing the liveness state (via communications 530), which can include the L2 SA/DA, L3 SA/DA, and outgoing interface in the Application Programming Interface (API).

According to some examples, the method includes PM-LC 510 downloading (via communications 526) endpoint sessions on PM-LC 510 at step 606.

According to some examples, in step 608, PM-LC 510 pre-routes Two-Way Active Measurement Protocol (TWAMP) packets via the SPIO or NETIO process (e.g., process 512) over the outgoing interface. Optionally, for a bundle with members across different LCs, the probe reply can come back on a different LC, as noted in block 618. Further, the frequency of the Liveness can be low (e.g., 3-10 seconds), as noted in block 620.

According to some examples, in step 610, when a failure occurs in one of the Liveness sessions (i.e., a failure of the liveness) detection, ARP-RP 506 is notified to remove the corresponding entry from the ARP table.

According to some examples, in step 612, ARP-RP 506 deletes (communication 532) the route cache of ARP/ND (LC) 552 for entries that correspond to failed liveness detections.

According to some examples, in process 614, ARP/ND (LC) 552 receives the instructions to delete respective entries in the route cache, and ARP/ND (LC) 552 notifies AIB (LC) 550 to update L2/L3 routes (via communications 556). Process 614 also includes step 622, step 624, and step 626.

At step 622, L3 routes (e.g., connected and/or static) are removed. This removal can be performed, e.g., by AIB (LC) 550 notifying L3 FIB 548 which notifies L3 RIB 546, which notifies BGP (RP) 542 to remove L3 route.

At step 624, L2 routes are removed. This removal can be performed, e.g., by ARP/ND (LC) 552 notifying AIB (LC) 550 which notifies L2 FIB 548 which notifies L2 RIB 546 which notifies BGP (RP) 542 to remove the L2 routes.

At step 626, ARP-RP 506 deletes the Liveness session (communications 524). For example, this can be performed by reversing the process at step 606).

According to some examples, in step 616, BGP 504 withdraws the advertised L2/L3 routes.

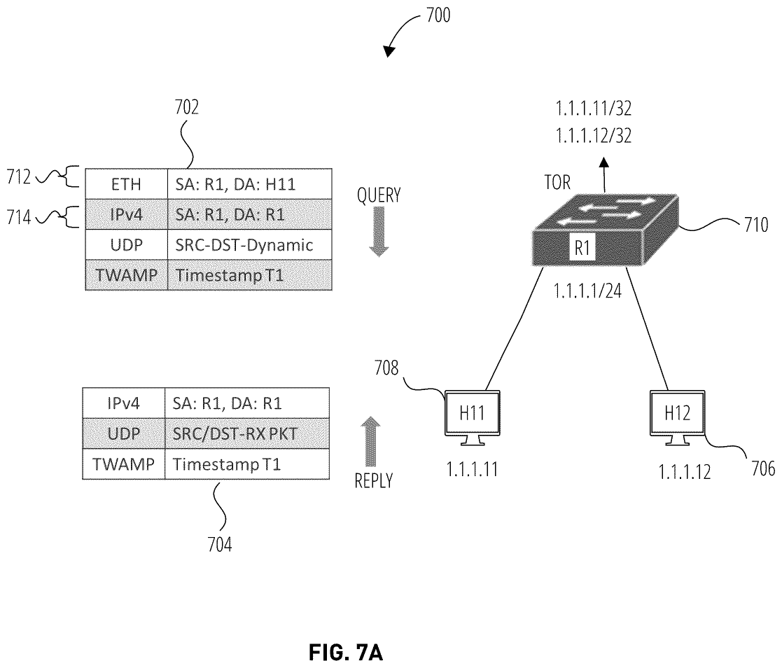

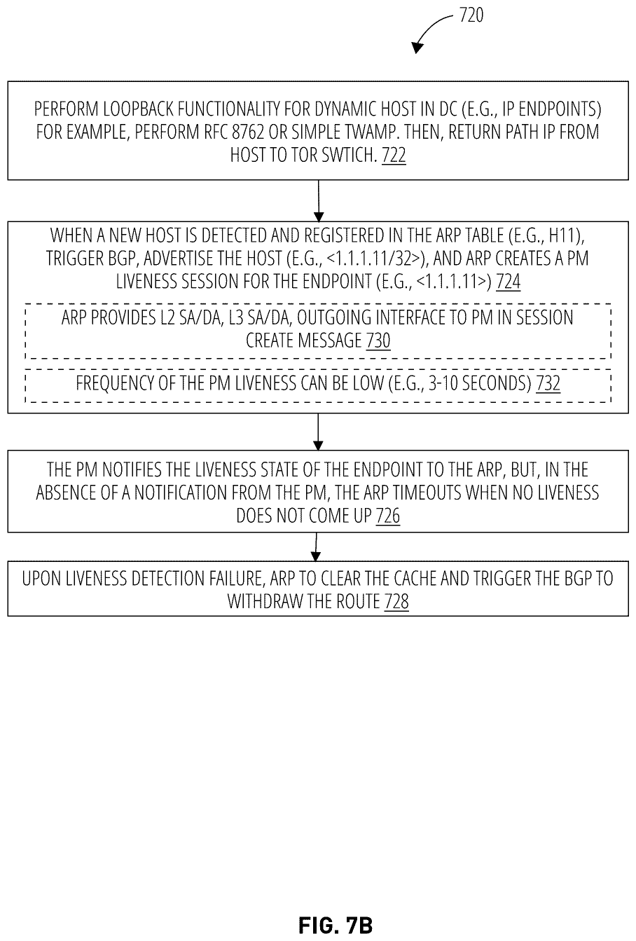

FIG. 7A illustrates a block diagram of a Liveness session 700 for dynamic-local-host-endpoint liveness detection. FIG. 7B illustrates a corresponding flow diagram for the liveness detection method 720.

Liveness session 700 includes a query 702 and a reply 704. ToR switch R1 710 is connected to two hosts (i.e., H12 706 and H11 708). Query 702 for the Liveness session for H11 208 includes various fields, which are illustrated as: (i) the Ethernet (ETH) field has value “SA: R1, DA: H11”, where SA is the Source Address and DA is the Destination Address); ii) the IPv4 field has value “SA: R1, SA: R1”; (iii) the UDP field has value “SRC=DST=Dynamic”, where SRC is Source Port and DST is Destination Port; and (iv) the TWAMP field has value “Timestamp T1”. The field ETH provides inject L2 PKT 712, and the field IPv4 provides return path 714. In the UDP field, the statement “SRC=DST=Dynamic” means that Source Port and Destination UDP ports are the same and are dynamically assigned by the PM process

Reply 704 for the Liveness session for H11 208 includes various fields, which are illustrated as: (i) the IPv4 field has value “SA: R1, SA: R1”; (ii) the UDP field has value “SRC/DST-RX PKT”, where SRC is Source Port, DST is Destination Port, and RX-PKT is the received packet; and (iii) the TWAMP field has value “Timestamp T1”. In the UDP field, the statement “SRC=DST-RX-Pkt means that for the UDP port the Source and Destination Ports are copied from the Received packet.

FIG. 7B illustrates an example liveness detection method 720 for the Liveness session 700 for dynamic-local-host-endpoint liveness detection. Although the example Liveness session 700 depicts a particular sequence of operations, the sequence may be altered without departing from the scope of the present disclosure. For example, some of the operations depicted may be performed in parallel or in a different sequence that does not materially affect the function of Liveness session 700. In other examples, different components of an example device or system that implements Liveness session 700 may perform functions at substantially the same time or in a specific sequence.

According to some examples, step 722 performs loopback functionality for dynamic hosts in data center 204 (e.g., IP endpoints). This loopback functionality can be performed for example using RFC 8762 or using Simple Two-Way Active Measurement Protocol (STAMP). Then, reply 704 is returned via return path 714 from the host (e.g., H11 208) to the ToR switch (e.g., switch R1 710).

According to some examples, in process 724, the entry of a new host (e.g., H11) in the ARP table (e.g., ARP table 302) triggers the BGP to advertise the host (e.g., <1.1.1.11/32>) and to create a Liveness session for the endpoint (e.g., <1.1.1.11>). Process 724 can include step 730 and block 732. In step 730, the ARP provides to the PM in session L2 source/destination MAC addresses (SA/DA), L3 source/destination IP addresses SA/DA, and an outgoing interface (e.g., fields ETH and IPv4 in query 702 and reply 704). In block 732, it is noted that the frequency of the Liveness probes can be low (e.g., 3-10 seconds).

According to some examples, in step 726, reply 704 notifies the liveness state of the endpoint (e.g., H11 708) to the ARP, but, in the absence of a notification from the Liveness detection, the ARP timeouts in the absence of liveness state in reply 704.

According to some examples, in step 728, when a liveness detection failure occurs (e.g., there is no liveness in the reply 704 causing the ARP to timeout), the ARP clears the cache for the missing host and triggers the BGP to withdraw the route for the missing host.

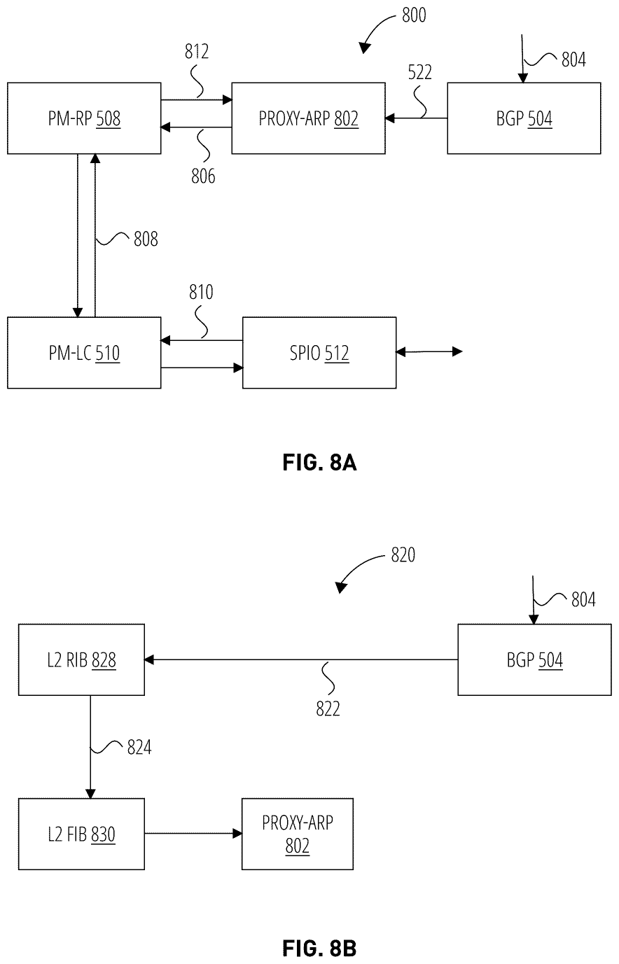

FIG. 8A illustrates a system 3 800 for dynamic BGP next-hop tracking liveness detection. Similar to system 1 502, system 3 800 includes a BGP 504, a PM-RP 508, a PM-LC 510, and a SPIO or NETIO process 512. Additionally, system 3 800 includes a proxy-ARP 802.

Like in FIG. 5A, blocks of system 3 800 interact and perform various functions. The BGP 504 performs a function of receiving advertised routes via communications 804. and the BGP 504 sends one or more instructions that signal proxy-ARP 802 to trigger PM sessions via communications 522. Proxy-ARP 802 sends one or more instructions to the PM-RP 508 to create/delete sessions via communications 806, and PM-RP 508 provides the liveness state via communications 812 to proxy-ARP 802. PM-RP 508 sends one or more instructions to download via communications 808 the end point session on PM-LC 510. The PM-LC 510 sends one or more instructions to SPIO or NETIO process (e.g., process 512) regarding the probe packets via communications 810.

FIG. 8B illustrates a system 4 820 that includes BGP 504, an L2 RIB 828, an L3 L2 FIB 830, and a proxy-ARP 802.

Blocks of system 4 820 interact and perform various functions. BGP 504 performs a function of receiving the advertised routes via communications 804. BGP 504 sends one or more instructions to L2 RIB 828 to update L2 host routes via communications 822. L2 RIB 828 sends one or more instructions to L2 FIB 830 to add/delete route via communications 824, and L2 FIB 830 sends one or more instructions to proxy-ARP (proxy process of ARP) 802 to add/delete route via communications 824.

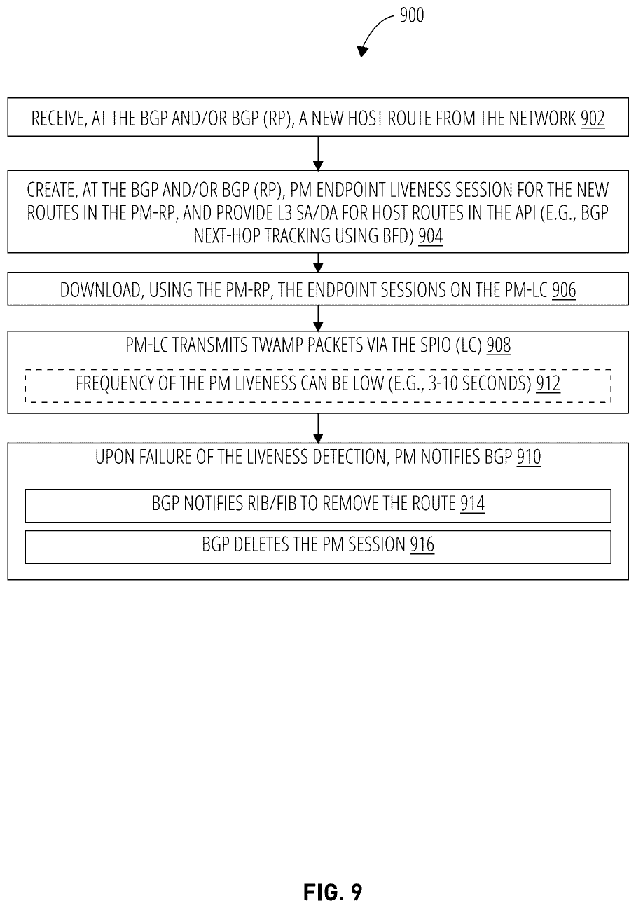

FIG. 9 illustrates an example of a remote IP subnet method 900 that uses system 3 800 and system 4 820 for dynamic BGP next-hop tracking liveness detection. Although the example remote IP subnet method 900 depicts a particular sequence of operations, the sequence may be altered without departing from the scope of the present disclosure. For example, some of the operations depicted may be performed in parallel or in a different sequence that does not materially affect the function of the remote IP subnet method 900. In other examples, different components of an example device or system that implements the remote IP subnet method 900 may perform functions at substantially the same time or in a specific sequence.

According to some examples, in step 902, the BGP (e.g., BGP 504) receives a new host route from the network.

According to some examples, in step 904, the BGP creates (via communications 806) Liveness endpoint session for the new routes in the PM (RP) to thereby provide L3 SA/DA for the host route in the API (e.g., BGP next-hop tracking using Bidirectional Forwarding Detection (BFD) protocol or BGP next-hop tracking using performance measurement with STAMP or TWAMP protocol).

According to some examples, in step 906, PM-RP 508 downloads (via communications 808) the endpoint sessions on the PM (LC) at step 906.

According to some examples, in step 908, PM-LC 510 transmits (via communications 810) TWAMP or STAMP packets via the SPIO or NETIO process (e.g., process 512) of the line card (LC) in loopback mode. Block 912 notes that the Liveness probes can occur infrequently (e.g., with a frequency of about 3-10 seconds). In a variant, probes may be employed with faster intervals.

According to some examples, in process 910, when a failure occurs for the liveness detection, Liveness session notifies BGP 504 regarding the failure (e.g., the host is missing or has moved to another switch). Process 910 can include step 914 and 916. In step 914, BGP 504 notifies Layer-2 (L2) RIB 828 and L2 FIB 830 to remove the route (822 and 824). In step 914, BGP 504 deletes the Liveness session.

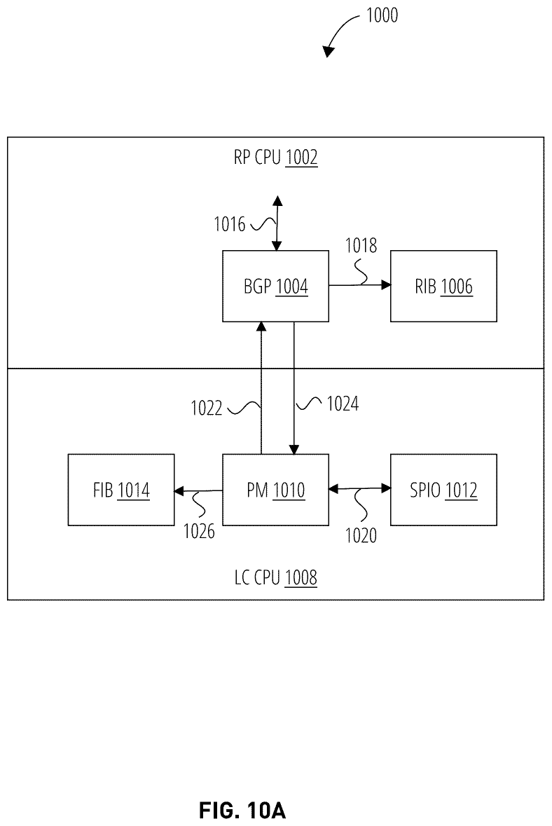

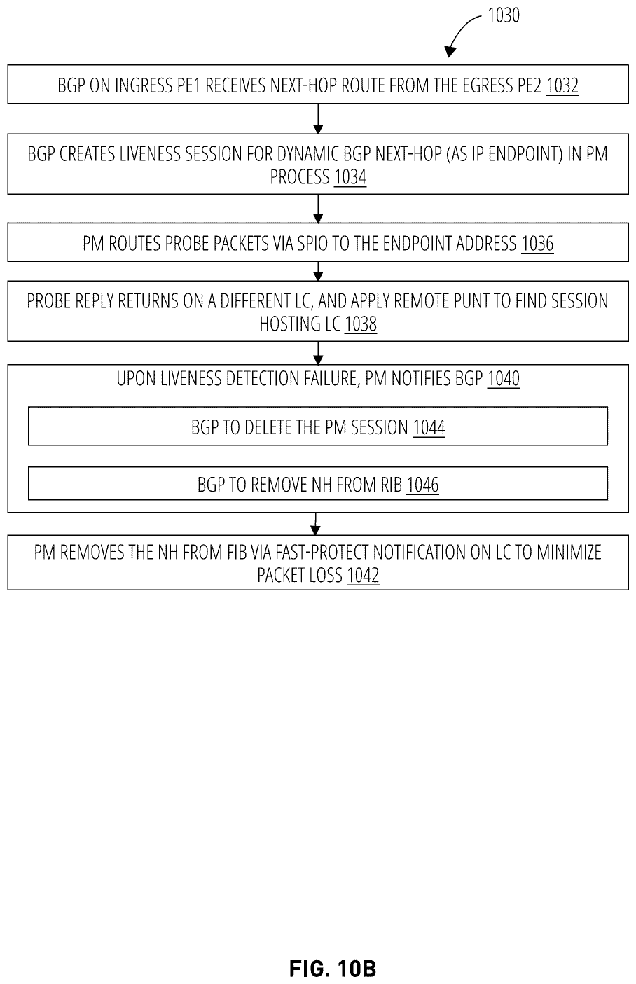

FIG. 10A illustrates an example a next-hop tracking system 1000 that includes a route processor central processing unit RP CPU 1002 and a line card central processing unit LC CPU 1008. RP CPU 1002 includes a BGP 1004 and a RIB 1006. LC CPU 1008 includes a performance measurement unit PM 1010, a NETIO or SPIO 1012, a FIB 1014.

The blocks of next-hop tracking system 1000 interact and perform various functions. For example, BGP 1004 can advertise routes 1016 via communications. Further, BGP 1004 sends one or more instructions to RIB 1006 to download routes via communications 1018, and BGP 1004 sends one or more instructions to PM 1010 to create/delete sessions via communications 1024. PM 1010 sends one or more instructions to BGP 1004 regarding the liveness state via communications 1022. PM 1010 also sends one or more instructions to FIB 1014 to remove the next hop (NH) via communications 1026. PM 1010 also communicates with NETIO or SPIO 1012 to inject the packets via communications 1020 to the host route.

FIG. 10B illustrates an example next-hop tracking system 1000 for dynamic BGP next-hop tracking and liveness detection. Although the example next-hop tracking system 1000 depicts a particular sequence of operations, the sequence may be altered without departing from the scope of the present disclosure. For example, some of the operations depicted may be performed in parallel or in a different sequence that does not materially affect the function of the next-hop tracking system 1000. In other examples, different components of an example device or system that implements the next-hop tracking system 1000 may perform functions at substantially the same time or in a specific sequence.

According to some examples, at step 1032, BGP 1004 on an ingress provider edge (e.g., PE1) receives (1016) next-hop route from an egress provider edge (e.g., PE2).

According to some examples, in step 1034, BGP 1004 creates (via communications 1024) in PM 1010 a Liveness session for a dynamic BGP next-hop (e.g., the IPv4/IPv6 endpoint).

According to some examples, in step 1036, PM 1010 routes probe packets via SPIO or NETIO to the IP endpoint address.

According to some examples, in step 1038, a probe reply returns on a different LC. step 1038 further includes applying a remote punt of the probe packet from the receiving LC to find the PM session hosting LC.

According to some examples, in process 1040 of method 1030, when the liveness detection fails, PM 1010 notifies BGP 1004 (1022).

According to some examples, in step 1042, PM 1010 signals to 1014 to remove the next hop (NH) from FIB 1014, which can be performed via fast-protect notification on LC to minimize packet loss.

According to some examples, in step 1044, BGP 1004 deletes the PM session.

According to some examples, in step 1046, BGP 1004 removes next hop (NH) from RIB 1006.

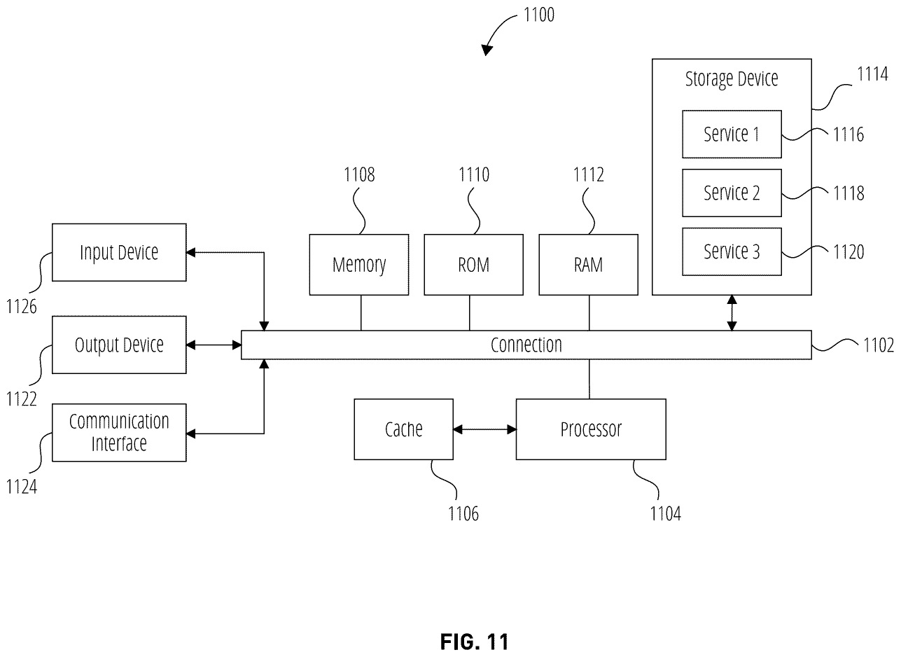

FIG. 11 shows an example of computing system 1100. Computing system 1100 can be the elements of data center 204, for example. Computing system 1100 can perform the functions of one or more of the servers, switches, routers, data center fabric, or other parts of one of the data centers disclosed herein. Computing system 1100 can be part of a distributed computing network in which several computers perform respective steps of method 400, method 600, method 720, method 900, and/or method 1030 or the functions of data center 204 and/or any of the systems disclosed herein (e.g., system 300, system 1 502, system 2 540, system 3 800, system 4 820, or system 1000). Computing system 1100 can be connected to the other parts of the distributed computing network via connection 1102 or communication interface 1124. Connection 1102 can be a physical connection via a bus, or a direct connection into processor 1104, such as in a chipset architecture. Connection 1102 can also be a virtual connection, networked connection, or logical connection.

In some embodiments, computing system 1100 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 1100 includes at least one processing unit (CPU or processor) 1104 and connection 1102 that couples various system components including system memory 1108, such as read-only memory (ROM) 1110 and random-access memory (RAM) 1112 to processor 1104. Computing system 1100 can include a cache of high-speed memory 1106 connected directly with, in close proximity to, or integrated as part of processor 1104. Processor 1104 may essentially be a completely self-contained computing system, containing multiple cores or processors, a bus, memory controller, cache, etc. A multi-core processor may be symmetric or asymmetric.

Processor 1104 can include any general-purpose processor and a hardware service or software service, such as services 1116, 1118, and 1120 stored in storage device 1114, configured to control processor 1104 as well as a special-purpose processor where software instructions are incorporated into the actual processor design.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multimodal systems can enable a user to provide multiple types of input/output to communicate with computing system 1100. Computing system 1100 can include a communication interface 1124, which can generally govern and manage the user input and system output. There is no restriction on operating on any particular hardware arrangement, and therefore the basic features here may easily be substituted for improved hardware or firmware arrangements as they are developed.

Storage device 1114 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

Storage device 1114 can include software services, servers, services, etc., that when the code that defines such software is executed by processor 1104, it causes the system to perform a function. In some embodiments, a hardware service that performs a particular function can include the software component stored in a computer-readable medium in connection with the necessary hardware components, such processor 1104, connection 1102, output device 1122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, e.g., instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of routing packets in a partitioned subnet, the method comprising:
advertising, by a data center to peers of the data center, a first host using a first address prefix;
routing, within a fabric of the data center, traffic to the first host using a second address prefix for a host route of the first host within the fabric of the data center, wherein the second address prefix is a longer prefix than the first address prefix;
performing, by a first switch of the data center, a first probe that detects whether the first host is linked to the first switch; and
updating a first table of the first switch based on a first result of the first probe.

2. The method of claim 1, further comprising:
updating a first table by adding to the first table the second address prefix in association with a MAC address of the first host;
triggering a gateway protocol for the host route of the first host to advertise the second address prefix for the host route of the first host within the fabric of the data center; and
configuring a performance measurement session for the host route of the first host.

3. The method of claim 1, wherein,
the data center aggregates a plurality of host routes within the fabric of the data center into the first address prefix, wherein the plurality of host routes includes the host route of the first host to a single; and
the plurality of host routes are de-aggregated from the first address prefix by redistributing the plurality of host routes using a gateway protocol that is triggered upon the host route of the first host or the second address prefix being added to or removed from the first table.

4. The method of claim 3, wherein the gateway protocol is a border gateway protocol or an interior gateway protocol.

5. The method of claim 1, wherein the method is performed in a network layer that is a layer 3 of an open systems interconnection model.

6. The method of claim 1, wherein,
the first host is a virtual machine running on a first server that is linked to the first switch, and
the data center includes a second server that is linked to a second switch.

7. The method of claim 6, furthering comprising:
moving the first host from the first server to the second server;
performing a second probe by the first switch that returns a second result indicating that the first host is not running on the first server; and
removing the host route of the first host from the first table.

8. The method of claim 7, furthering comprising:
performing a third probe by the second switch that returns a third result indicating that the first host is running on the second server; and
adding the host route of the first host to a second table, wherein the second table is associated with host routes of the second switch.

9. The method of claim 1, furthering comprising:
performing a second probe by a second switch, the second probe returning a second result indicating that the first host is linked to the second switch; and
adding the host route of the first host to a second table, wherein the second table is associated with host routes of the second switch, wherein the first host is a virtual machine that is dual-homed, such that the virtual machine is linked to the first switch and is linked to the second switch.

10. The method of claim 1, wherein:
the first address prefix is a /24 prefix;
the second address prefix is a /32 prefix;
the first table is an address resolution protocol table;
the first switch is a top-of-rack switch;
the first probe is a performance measurement liveness probe; and
the first host is a virtual machine or a virtual network function.

11. A system for routing packets in a network that has partitioned subnets, comprising:
a data center comprising:
a fabric of the data center;
a first switch; and
a first server configured to run a first host that is linked to the first switch, wherein,
the data center is configured to:
advertise, to peers of the data center, a first host using a first address prefix, and
route, within the fabric of the data center, traffic to the first host using a second address prefix for a host route of the first host within the fabric of the data center, the second address prefix being a longer prefix than the first address prefix; and
the first switch is configured to:
perform a first probe that detects whether the first host is linked to the first switch, and
update a first table of the first switch based on a first result of the first probe.

12. The system of claim 11, wherein the first switch is further configured to:
update a first table by adding to the first table the second address prefix in association with a MAC address of the first host;
trigger a gateway protocol for the host route of the first host to advertise the second address prefix for the host route of the first host within the fabric of the data center; and
configure a performance measurement session for the host route of the first host.

13. The system of claim 11, wherein the data center is further configured to:
aggregate a plurality of host routes within the fabric of the data center into the first address prefix, wherein the plurality of host routes includes the host route of the first host to a single; and
de-aggregate the plurality of host routes from the first address prefix by redistributing the plurality of host routes using a gateway protocol that is triggered upon the host route of the first host or the second address prefix being added to or removed from the first table.

14. The system of claim 13, wherein the gateway protocol is a border gateway protocol or an interior gateway protocol.

15. The system of claim 11, wherein the data center is configured to advertise, route, perform, and update in a network layer that is a layer 3 of an open systems interconnection model.

16. The system of claim 11, further comprising:
a second switch;
a first server that is linked to the fabric of the data center via the first switch; and
a second server that is linked to the fabric of the data center via the second switch, wherein the first host is a virtual machine running on the first server that is linked to the first switch.

17. The system of claim 16, wherein, when the first host is moved from the first server to the second server:
the first switch is configured to:
perform a second probe that returns a second result indicating that the first host is not running on the first server, and
remove the host route of the first host from the first table; and
the second switch is configured to:
perform a third probe that returns a third result indicating that the first host is running on the second server, and
add the host route of the first host to a second table, wherein the second table is associated with host routes of the second switch.

18. The system of claim 16, wherein the second switch is configured to:
perform a second probe returning a second result indicating that the first host is linked to the second switch; and
add the host route of the first host to a second table, wherein,
the second table is associated with host routes of the second switch, and
the first host is a virtual machine that is dual-homed, such that the virtual machine is linked to the first switch and is linked to the second switch.

19. The system of claim 11, wherein:
the first address prefix is a /24 prefix;
the second address prefix is a /32 prefix;
the first table is an address resolution protocol table;
the first switch is a top-of-rack switch;
the first probe is a performance measurement liveness probe; and
the first host is a virtual machine or a virtual network function.

20. A computing apparatus comprising:
a processor; and
a memory storing instructions that, when executed by the processor, configure the computing apparatus to:
advertise, by a data center to peers of the data center, a first host using a first address prefix;
rout, within a fabric of the data center, traffic to the first host using a second address prefix for a host route of the first host within the fabric of the data center, wherein the second address prefix is a longer prefix than the first address prefix;
perform, by a first switch of the data center, a first probe that detects whether the first host is linked to the first switch; and
update a first table of the first switch based on a first result of the first probe.
